(19) United States
(12) Patent Application Publication
(10) Pub. No.: US 2008/0005041 A1
(43) Pub. Date: Jan. 3, 2008

(54) Method and apparatus for compensating electronics designers

(75) Inventors: Daniel Thomas Cwieka, Laguna Beach, CA (US); Todd Michael Breton, Carlsbad, CA (US); Todd Gary Stewart, Carlsbad, CA (US); Greg Michael Lange, Oceanside, CA (US)

Correspondence Address: Kenton R. Mullins;Stout, Uxa, Buyan & Mullins, LLP, Suite 300, 4 Venture, Irvine, CA, 92618, US

(73) Assignee: Ones and Zeros Technologies, Inc., San Clemente, CA (US)

(21) Appl. No.: 11/809,015

(22) Filed: May 30, 2007

Related U.S. Application Data
(60) Provisional application No. 60/809,584, filed on May 30, 2006.

(51) Int. Cl. G06F 17/00

(52) U.S. Cl. 705/400

(57) ABSTRACT

A method for compensating printed circuit board designers includes receiving registration information from a registrant and assigning a unique identifier to the registrant. Printed circuit board designs, which are received from the registrant and which include the unique identifier, are used to provide residual compensation to the registrant. The compensation relates to the manufacture of printed circuit board designs through out a manufacturing life of a printed circuit board product.

### CROSS-REFERENCE TO RELATED APPLICATIONS

This application claims the benefit of U.S. Provisional Application No. 60/809,584, filed May 30, 2006, the entire contents of which are hereby incorporated by reference.

### BACKGROUND OF THE INVENTION

1. Field of the Invention

The present invention relates generally to electronics designs and, more particularly, to the fabrication of electronic devices based upon those designs.

2. Description of Related Art

Electronic devices including, for example, printed circuit boards (PCBs), can play an essential role in the implementation of commercial and/or military products. Simple two-layer PCBs may be used to provide interconnection among a few electronic elements such as resistors, capacitors, switches, and the like. For more complicated PCB designs involving large numbers of interconnected integrated circuits, multi-layer PCBs may be required. Multi-layered PCBs that may include up to, for example, 24 layers may be found in such products as computers, cell phones, music players, and the like.

The design of a PCB comprising a large number of layers can be an extremely complicated and difficult task, as can be the fabrication of such a PCB after it has been designed. Typically, an original equipment manufacturer (OEM) that manufactures, markets and sells electronic products and devices may arrange to have PCBs fabricated by a third-party manufacturer or fabricator who specializes in PCB fabrication under terms of a contractual arrangement. PCB design engineers may perform PCB design services as employees of an OEM or as free-lance subcontractors.

### SUMMARY OF THE INVENTION

The invention herein disclosed, according to one implementation, comprises a method of compensating electronics designers (e.g., design engineers), including receiving registration information from a registrant, who may be an electronics designer. A marketing agreement is created with the registrant, and a unique identifier is assigned to the registrant. An electronics design is received from the registrant, the electronics design including the unique identifier. Compensation is calculated according to the unique identifier and the marketing agreement. According to another implementation, compensation is paid to the registrant. The receiving of an electronics design may comprise, according to another implementation, receiving a schematic diagram. According to yet another implementation, the receiving of an electronics design may comprise receiving a printed circuit board design. In another implementation, the receiving of a printed circuit board design may comprise receiving a fabrication drawing. Still another implementation may comprise receiving a printed circuit board design in a form of a Gerber file.

A particular embodiment of the present invention comprises an apparatus including a registration unit adapted to receive registration information from a registrant and further may comprise an identifier generator adapted to generate an identifier unique to the registrant. The embodiment, further, may comprise an identifier detector adapted to detect the unique identifier in an electronics design and still further may comprise a compensation calculator adapted to calculate compensation according to the unique identifier and according to a marketing agreement with the registrant.

While the apparatus and method has or will be described for the sake of grammatical fluidity with functional explanations, it is to be expressly understood that the claims, unless expressly formulated under 35 U.S.C. 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. 112 are to be accorded full statutory equivalents under 35 U.S.C. 112.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention are described herein. Of course, it is to be understood that not necessarily all such aspects, advantages or features will be embodied in any particular embodiment of the present invention. Additional advantages and aspects of the present invention are apparent in the following detailed description and claims that follow.

### BRIEF DESCRIPTION OF THE FIGURES

FIG. 1 is a flow diagram of a particular implementation of a method of compensating electronics designers;

FIG. 2 is a conceptual block diagram of an apparatus adapted to compensate electronics designers according to the implementation of FIG. 1;

FIG. 3 is a portion of a fabrication drawing for a printed circuit board including a unique identifier; and

FIG. 4 is a block diagram of a computer adapted to compensate electronics designers according to the implementation of FIG. 1.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the disclosed methods of providing compensation to electronics designers. The present invention may be practiced in conjunction with various methods and techniques that are conventionally used in the art, and only so much of the commonly practiced process steps are included herein as are necessary to provide an understanding of the present invention. The present invention has applicability in the field of electronics manufacture in general. For illustrative purposes, however, the following description pertains to devices and methods of compensating designers of electronics including printed circuit boards.

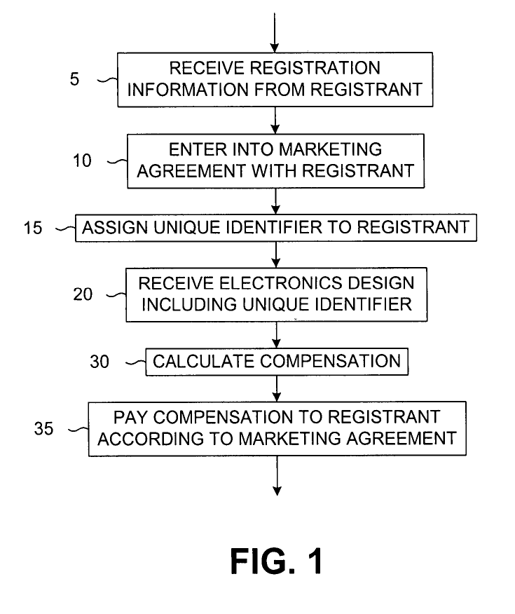

Referring more particularly to the drawings, FIG. 1 describes one particular implementation of a method of compensating electronics designers according to an aspect of the present invention. According to the illustrated implementation, registration information is received from a registrant at step 5. The registrant (e.g., client) may be an agent of a corporation or may be an electronics designer who either represents a company or is in business for himself or herself. According to one embodiment, the registrant, who is a designer of printed circuit boards, accesses a client system provided by a fabricator or a company that represents fabricators of printed circuit boards (i.e., “the company”) and provides registration information, which information is subsequently received by the company at step 5. The client system may be accessible by the registrant through a computer network such as the Internet. The company may then approve the information provided by the registrant and enter into a marketing agreement (e.g., an exclusive marketing agreement) with the registrant at step 10. The company may then assign a unique identifier to the registrant at step 15.

In typical implementations, the unique identifier assigned to the registrant is then included in electronics designs (e.g., schematic diagrams) created by the client. The unique identifier may be associated with (e.g., embedded within) each electronics design (e.g., a printed circuit board design) prepared by the client and submitted, by the client or some other entity, to the company for fabrication. The electronics design (e.g., printed circuit board design) may be in a form of plans, fabrication drawings or Gerber files (a standard file format used by printed circuit board fabricators, the format containing information used by computer controlled machines to lay out printed circuit boards). For example, the client may include his/her unique identifier within a statement of the electronics design. One example of a statement may be, “Preferred PCB Manufacturer: www.fabco.com, Client ID 1234567.” (The reference to www.fabco.com is fictitious and is included herein for illustration purposed only.) Alternatively, the unique identifier may be included on or in connection with another part of the electronics design.

An electronics design (e.g., a printed circuit board design) that includes the unique identifier is received at step 20. Typically, the company will receive the design, including the unique identifier, and thereby will be able, even on recurring printed circuit board production orders, to identify the original author of a printed circuit board design prior or subsequent to fabrication (e.g., manufacturing). From time to time (e.g., quarterly), an amount of compensation may be calculated at step 30 according, for example, to one or more of a quantity of printed circuit boards actually fabricated and the unique identifier associated with the design of the printed circuit board(s). In accordance with one representative embodiment, the compensation is calculated at 1% of all revenue received by the company for the manufacture of printed circuit boards associated with the unique identifier of a registrant, during the relevant time period. Payment is paid to the registrant according to the marketing agreement at step 30.

It should be clear that the implementation of the method summarized in FIG. 1 confers great benefit upon printed circuit board designers who elect to register with the company and who include their unique identifier on their printed circuit board designs. Designers are then able to track and/or benefit from current and/or future production runs of their printed circuit board designs. The company may benefit from the implementation of the method as well, as a result of an incentive for printed circuit board designers to specify the company as a preferred manufacturer, thereby creating a competitive advantage for the company.

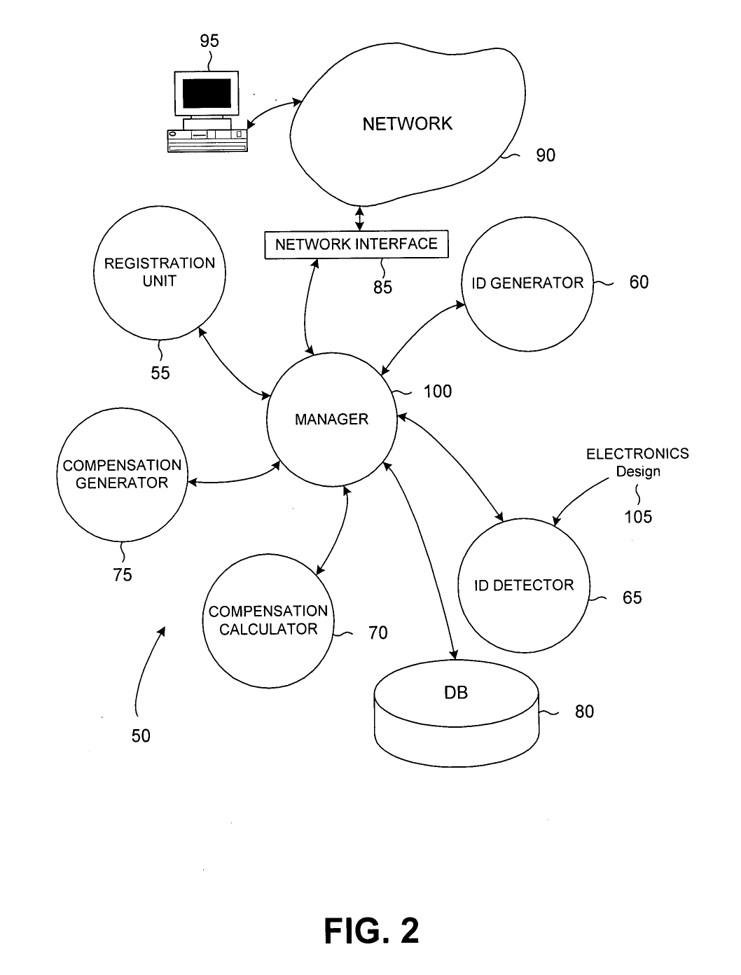

FIG. 2 is a conceptual block diagram of an apparatus (e.g., a “client system”) 50 adapted to compensate electronics designers (e.g., printed circuit board designers) according to the implementation summarized in connection with FIG. 1. The illustrated embodiment comprises a registration unit 55 adapted to process registration information received from a registrant, an ID generator 60 adapted to generate a unique identifier according to the registration information, and an ID detector 65 adapted to discern a unique identifier according to a registrant in a printed circuit board design. The embodiment further comprises a compensation calculator 70 and a compensation generator 75. The embodiment still further comprises a manager module 100 adapted to coordinate operation of the aforementioned components and a database 80 in which registrant information may be stored. According to a typical implementation, a network interface 85 provides a communicative connection to a network 90 to which may be connected, for example, a computer terminal 95 that may be used by a client to access the client system.

According to a typical mode of operation, the client accesses the client system 50 from the computer terminal 95 through the network 90 and the network interface 85. The client communicates with the manager module 100 and may interact with the manager module 100 to submit registration information, which the manager module 100 passes to the registration unit 55. The registration unit 55 may create a database file for the client, the database file comprising information according to the received registration information, and the database file may be passed to the manager module 100. The manager module 100 may pass a portion of the information in the database file to the ID generator 60, which may create a unique identifier for the client and which may pass the unique identifier back to the manager module 100. The manager module 100 may add the unique identifier to the information already in the database file and may store the database file in the database 80.

An electronics design 105 (e.g., a printed circuit board design) may be received by the ID detector 65, which may detect a unique identifier on the printed circuit board design, the unique identifier corresponding to a client. As one example, the ID detector 65 may comprise a scanner adapted to employ optical character recognition to detect the unique identifier in a fabrication drawing. According to another embodiment, the ID detector 65 detects the unique identifier in a Gerber file representing the printed circuit board design. In any case, the ID detector 65 may pass the detected unique identifier to the manager module 100, which may interact with an accounting module (not shown) and store in the database information pertaining to, for example, one or more of a quantity of printed circuit boards manufactured, payment received, and the unique identifier.

From time to time the manager module 100 may retrieve a database file from the database according to a unique identifier and may pass the database file to the compensation calculator 70. The compensation calculator 70 may determine, for example, a quantity of printed circuit boards ordered, delivered, and paid for according to a unique identifier and may determine a compensation amount for a printed circuit board designer associated with the unique identifier. The compensation amount may be added to the database file, and the database file returned to the manager module 100. The manager module 100 may pass the database file to the compensation generator 75 which may cause payment to be presented to the printed circuit board designer corresponding to the unique identifier. The compensation generator 75 may record the payment in the database file and may return the database file to the manager module 100, which may store the updated database file in the database 80. According to one embodiment, the compensation generator 75 comprises a printer adapted to print a compensation check that may be delivered to the client in a conventional manner (e.g., by mail). According to another embodiment, the compensation generator 75 creates a message suitable for transmitting money electronically and passes the message to the manager module 100, which interacts with the network 90 through the network interface 85 to deposit the compensation amount directly into a bank account of the client.

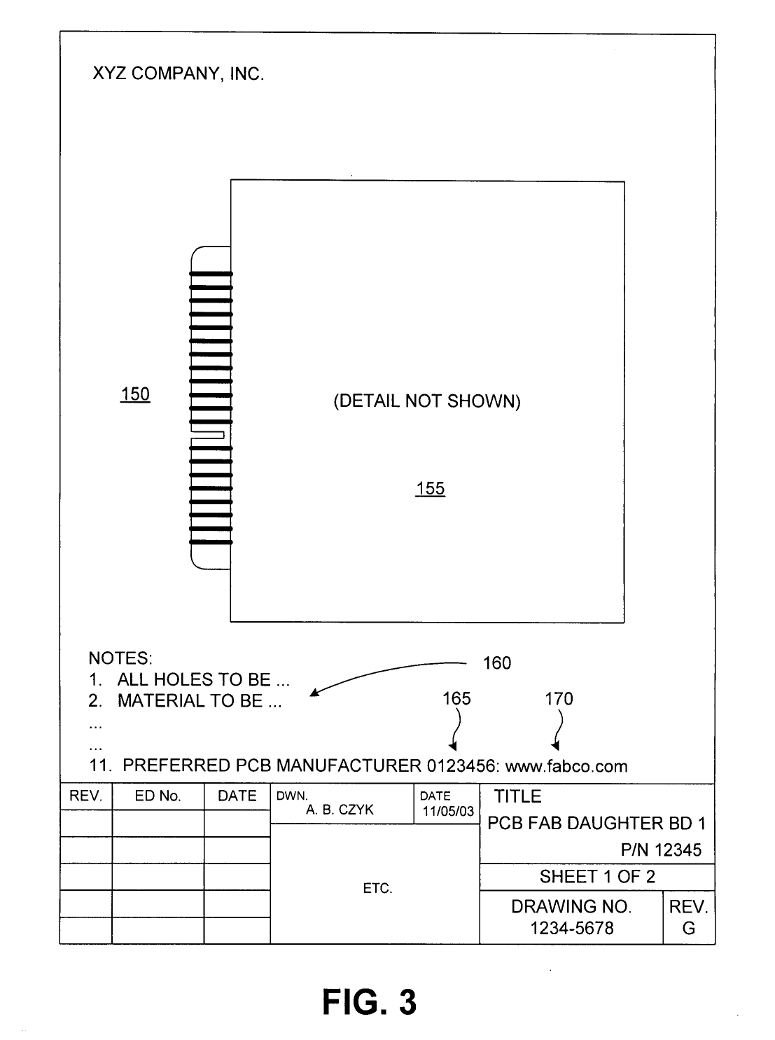

A portion of an exemplary printed circuit board fabrication drawing 150 is illustrated in FIG. 3. The illustrated example comprises an outline of a printed circuit board 155 containing details as to hole location and size, trace location and width, and the like (not shown in FIG. 3). The example further comprises notes 160 related to the printed circuit board design. In the example depicted in FIG. 3, one of the notes contains a statement, “PREFERRED PCB MANUFACTURER 0123456: www.fabco.com, where 0123456 165 is an example of a unique identifier according to a printed circuit board designer or client, and www.fabco.com 170 is a name of a fictitious printed circuit board fabricator (e.g., the company), which receives the printed circuit board design. As described supra with reference to FIG. 2, a scanner configured for optical character recognition may detect the unique identifier as described herein.

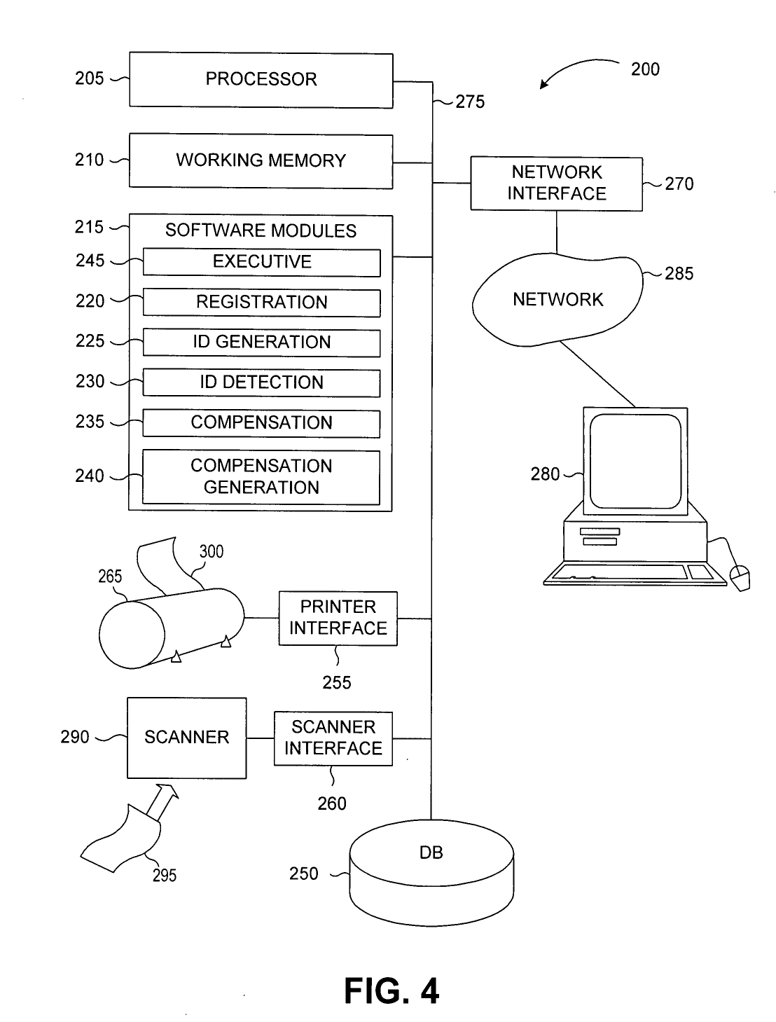

Another implementation that may be capable of compensating electronics designers (e.g., printed circuit board designers) is illustrated in FIG. 4 in a form of a computer system 200. The illustrated embodiment, which may be maintained and operated by a printed circuit board fabricator (e.g., the company), comprises a processor 205, memory, which may include, for example, working memory 210 and program memory 215 in which are stored a collection of software modules. Software modules for registration 220, ID generation 225, ID detection 230, compensation 235, and compensation generation 240, as well as an executive software module 245, are included in the exemplary implementation of FIG. 4. The particular example illustrated further includes a database 250, a printer interface 255, a scanner interface 260, and a network interface 270. The working memory 210, program memory 215, database 250, and interfaces 255, 260, and 270 are interconnected by a system bus 275 that facilitates intercommunication with the processor 205.

In operation, a printed circuit board designer (e.g., client) may access the computer 200 from a computer terminal 280 through a network 285 (e.g., the Internet) by way of the network interface 270. The executive software module 245 may cause the processor 205 to take note of the access, and the processor 205 may execute the registration software module 220 that may cause the processor 205 to receive registration information and to create or access a database file for the client. The database file, which may reside, for example, on a hard disk (e.g., the database 250) may comprise information according to the received registration information. The executive software module 245 may cause the processor 205 to execute the ID generation software module 225, which may cause the processor 205 to create a unique identifier for the client and to update the database file according to the unique identifier.

Thereafter, an electronics design (e.g., a printed circuit board design) may be received by the computer 200. The printed circuit board design may be received electronically through the network 285 in a form of, for example, Gerber files. Alternatively, a scanner 290 that communicates with the computer 200 through the scanner interface 260 may receive a fabrication drawing 295 having embedded thereon a unique identifier associated with a client as described supra with reference to FIG. 3. The processor 205 may execute the ID detection software module 230, which may cause the processor 205 to detect the embedded unique identifier using optical character recognition software (not shown). The executive software module 245 may cause the processor 205 to receive the unique identifier and to execute an accounting software module (not shown) to update the database file according to, for example, one or more of order information, shipping information, payment information, and the like associated with the printed circuit board design and the unique identifier.

A calendar software module (not shown) may cause the processor 205 to perform certain compensation functions on a schedule appropriate to a marketing agreement extant between the company and the client. For example, the executive software module 245 may cause the processor 205 to execute, according to the calendar software module, the compensation software module 235, which may cause the processor 205 to access the database file and to determine, for example, order, manufacture, delivery, and payment information according to the unique identifier, and may, consequently, calculate a compensation amount for the client. Information according to the compensation amount may be used to update the database file on the database 250. The executive software module 245, further, may cause the processor 205 to execute the compensation generation software module 240, which may cause the processor 205 to generate actual compensation for the client according to the updated database file. According to one embodiment, the compensation is delivered to the client electronically by making a direct deposit to a bank account of the client. According to another embodiment, the compensation generation software module 240 causes the processor 205 to interact with a printer 265 through the printer interface 255 to print a paper check 300 that then may be delivered by, for example, mail to the client.

It should be understood that the method summarized in FIG. 1 may be implemented in a form of computer software modules and/or instructions and stored on a computer-readable medium such as, for example, a CD-ROM, a DVD, a floppy disk, and the like. As such, the computer-readable medium may comprise computer-executable instructions for performing an implementation of the method summarized in FIG. 1.

In view of the foregoing, it will be understood by those skilled in the art that the methods of the present invention can facilitate compensation of electronics designers such as printed circuit board designers. Additionally, an electronics fabricator (e.g., a company) may employ the present invention to enhance revenue and to create a competitive advantage by offering a financial incentive for electronics designers to use services of the company in manufacturing electronics. Further, the present invention can enable electronics designers (e.g., printed circuit board designers) to track and/or benefit from current and/or future production runs of their electronics designs and to receive residual compensation for completed designs throughout the manufacturing life of the electronics products. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A method, comprising:
receiving registration information from a registrant;
assigning a unique identifier to the registrant;
receiving an electronics design from the registrant, the electronics design including the unique identifier; and
calculating compensation according to the unique identifier.

2. The method as set forth in claim 1, further comprising creating a marketing agreement with the registrant and paying compensation to the registrant, wherein the calculating comprises calculating compensation according to the unique identifier and the marketing agreement.

3. The method as set forth in claim 2, wherein the receiving of an electronics design comprises receiving a printed circuit board design.

4. The method as set forth in claim 3, wherein the receiving of a printed circuit board design comprises receiving a fabrication drawing.

5. The method as set forth in claim 3, wherein the receiving of a printed circuit board design comprises receiving a Gerber file.

6. The method as set forth in claim 1, wherein the assigning is preceeded by creating a marketing agreement with the registrant, the receiving of an electronics design comprises receiving a schematic diagram, and the calculating comprises calculating compensation according to the unique identifier and the marketing agreement.

7. An apparatus, comprising:
a registration unit adapted to receive registration information from a registrant;
an identifier generator adapted to generate an identifier unique to the registrant;
an identifier detector adapted to receive an electronics design that includes the unique identifier, wherein the identifier detector is further adapted to detect the unique identifier in the electronics design; and
a compensation calculator adapted to calculate compensation according to the unique identifier and a marketing agreement with the registrant.

8. The apparatus as set forth in claim 7, the compensation calculator being adapted to calculate compensation according to the unique identifier and a marketing agreement with the registrant, and the apparatus further comprising a compensation generator adapted to pay compensation to the registrant.

9. The apparatus as set forth in claim 7, wherein the electronics design comprises a printed circuit design.

10. The apparatus as set forth in claim 9, wherein:
the printed circuit design comprises a fabrication drawing; and
the identifier detector comprises a scanner adapted to discern the unique identifier in the fabrication drawing.

11. The apparatus as set forth in claim 9, wherein:
the printed circuit design comprises a Gerber file; and
the identifier detector is adapted to discern the unique identifier in the Gerber file.

12. The apparatus as set forth in claim 7, wherein:
the electronics design comprises a schematic diagram; and
the identifier detector comprises a scanner adapted to discern the unique identifier in the schematic diagram.

13. A computer, comprising:
a processor adapted to execute software instructions;
memory adapted to intercommunicate with the processor;
a network interface adapted to intercommunicate with a registrant over a network;
registration software stored in the memory, the registration software being adapted to cause the processor to receive registration information from the registrant;
identifier generation software stored in the memory, the identifier generation software being adapted to cause the processor to create an identifier unique to the registrant;
identifier detection software stored in the memory, the identifier detection software being adapted to cause the processor to detect the unique identifier in an electronics design;
compensation software stored in the memory, the compensation software being adapted to cause the processor to calculate compensation according to the unique identifier.

14. The computer as set forth in claim 13, the compensation software being adapted to cause the processor to calculate compensation according to the unique identifier and a marketing agreement with the registrant, and the computer further comprising compensation generation software stored in the memory, the compensation generation software being adapted to cause the processor to pay compensation to the registrant.

15. The computer as set forth in claim 13, wherein the identifier detection software is further adapted to cause the processor to detect the unique identifier in a printed circuit board design.

16. The computer as set forth in claim 13, further comprising:
a database adapted to store the registration information and the unique identifier;
a printer interface adapted to facilitate intercommunication between a printer and the computer; and
a scanner interface adapted to facilitate intercommunication between a scanner and the computer.

17. The computer as set forth in claim 16, wherein the identification detection software is further adapted to cause the processor to:
receive an input from the scanner according to a fabrication drawing; and
discern the unique identifier in the fabrication drawing using optical character recognition.

18. A computer-readable medium having computer-executable instructions for performing a method comprising:
receiving registration information from a registrant;
assigning a unique identifier to the registrant;
receiving an electronics design from the registrant, the electronics design including the unique identifier; and
calculating compensation according to the unique identifier and the marketing agreement.

19. The computer-readable medium as set forth in claim 18, and further comprising computer-executable instructions for:
creating a marketing agreement with the registrant;
calculating compensation according to the unique identifier and the marketing agreement; and
paying compensation to the registrant.

20. The computer-readable medium as set forth in claim 18, wherein the electronics design comprises a printed circuit board design.
